(19) United States
(12) Patent Application Publication
(10) Pub. No.: US 2016/0059467 A1
(43) Pub. Date: Mar. 3, 2016

(54) Mold structure

(71) Applicant: PO MING HUANG, Taichung City (TW)

(72) Inventor: PO MING HUANG, Taichung City (TW)

(21) Appl. No.: 14/470,943

(22) Filed: Aug. 28, 2014

(51) Int. Cl. B29C 49/00; B29C 33/60; B29C 49/64

(52) U.S. Cl. CPC B29C 49/0047; B29C 49/6409; B29C 33/60; B29C 2049/0068; B29K 2905/02; B29K 2905/08; B29L 2031/7404

(57) ABSTRACT

A mold structure contains: a first mold, an isolation washer, and a second mold. The first mold includes a ring-shaped closing rib arranged on a top surface thereof and a cavity defined in the closing rib. The isolation washer is formed in a ring shape and includes a melting point higher than a molding plate, wherein when the isolation washer retains with the fixing slot of the closing rib, and a top surface of the isolation washer is higher than that of the closing rib, the molding plate is held by the isolation washer. The second mold moves relative to the first mold to press a top surface of the molding plate, the second mold includes a close chamber defined on a bottom surface thereof and corresponding to the cavity and includes a gas supply pipe communicating with the close chamber and connecting with a high-pressure gas device.

### FIELD OF THE INVENTION

The present invention relates to a mold structure in which a molding plate and an isolation washer are removed from the first mold easily.

### BACKGROUND OF THE INVENTION

With reference to FIG. 1, a conventional mold structure is employed to blowing mold a molding plate 10, wherein the molding plate 10 is placed on a closing rib 12 of a first mold 11 to cover the cavity 13, and a second mold 14 moves downwardly to press the molding plate 10, a first heater 16 and a second heater 17 of a heating device 15 heat the first mold 11 and the second mold 14 so as to deform the molding plate 10 at a heating temperature, and a high-pressure gas device 18 of the second mold 14 inputs high-pressure gas into a close chamber 19 via a gas supply pipe 18 of the second mold 14, such that a pressure of the high-pressure gas presses the molding plate 10 into the cavity 13 so that the molding plate 10 forms in a shape of the cavity 13. Thereafter, the second mold 14 is moved upwardly to remove from the cavity 13, after the molding plate 10 is cooled. Finally, the molding plate 10 is trimmed to finish a molding product.

However, the heating device 15 heats the molding plate 10 through the first mold 11 and the second mold 14 at the heating temperature to deform the molding plate 10, but the molding plate 10 melts into the closing rib 12 of the first mold 11, thus removing the molding plate 10 difficulty.

In addition, the molding plate 10 can be only removed after cooling.

The present invention has arisen to mitigate and/or obviate the afore-described disadvantages.

### SUMMARY OF THE INVENTION

The primary object of the present invention is to provide mold structure by which after a molding plate is pressed by a first mold and the second mold and is heated by a heating device, a high-pressure gas device inputs a high-pressure gas into a close chamber via a gas supply pipe to blowing mold a close chamber, and the molding plate does not stick on the first mold by using an isolation washer but sticks on the isolation washer, hence since a melting point of the isolation washer is higher than the molding plate, the isolating washer does not stick on a cavity, such that after molding the molding plate, the molding plate and the isolation washer are removed from the first mold easily.

Another object of the present invention is to provide mold structure in which after molding the molding plate, it sticks with the isolation washer to enhance structural strength.

To obtain the above objects, a mold structure provided by the present invention contains: a first mold, an isolation washer, and a second mold.

The first mold includes a ring-shaped closing rib arranged on a top surface thereof and a cavity defined in the closing rib.

The isolation washer is formed in a ring shape and includes a melting point higher than a molding plate, wherein when the isolation washer retains with the fixing slot of the closing rib, and a top surface of the isolation washer is higher than that of the closing rib, the molding plate is held by the isolation washer.

The second mold moves relative to the first mold to press a top surface of the molding plate, the second mold includes a close chamber defined on a bottom surface thereof and corresponding to the cavity and includes a gas supply pipe communicating with the close chamber and connecting with a high-pressure gas device.

### BRIEF DESCRIPTION OF THE DRAWINGS

FIG. 1 is a cross sectional view showing the operation of a conventional mold structure.

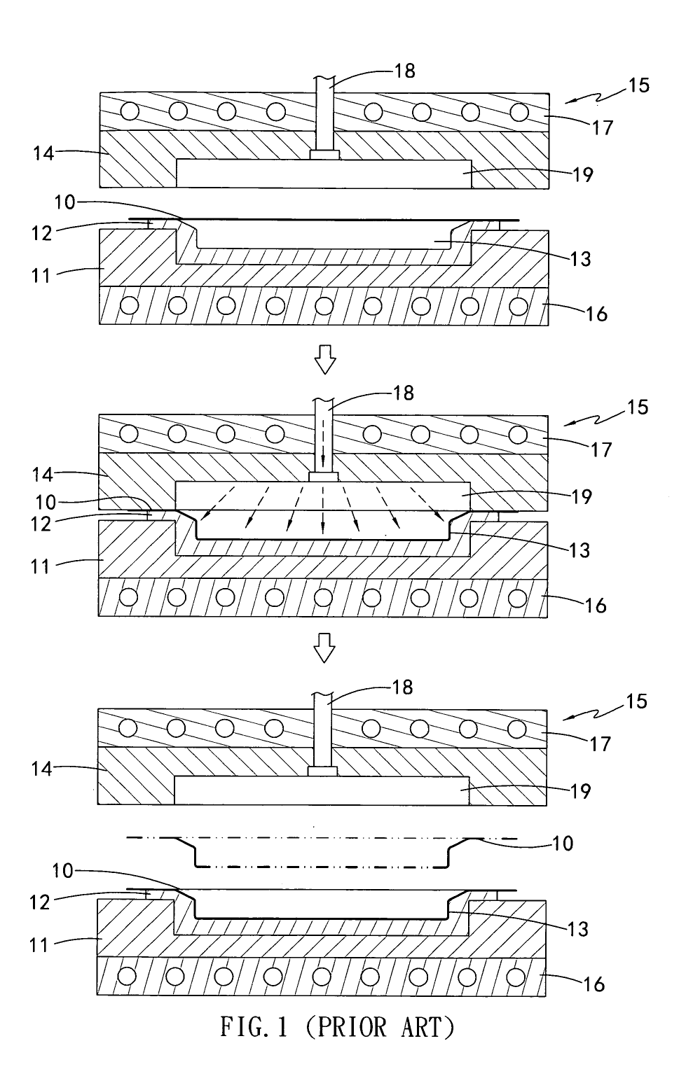

FIG. 2 is a perspective view showing the exploded components of a mold structure according to a preferred embodiment of the present invention.

FIG. 3 is a cross sectional view showing the exploded components of the mold structure according to the preferred embodiment of the present invention.

FIG. 4 is a cross sectional view showing the operation of the mold structure according to the preferred embodiment of the present invention.

FIG. 5 is another cross sectional view showing the operation of the mold structure according to the preferred embodiment of the present invention.

FIG. 6 is also another cross sectional view showing the operation of the mold structure according to the preferred embodiment of the present invention.

FIG. 7 is still another cross sectional view showing the operation of the mold structure according to the preferred embodiment of the present invention.

### DETAILED DESCRIPTION OF THE PREFERRED EMBODIMENTS

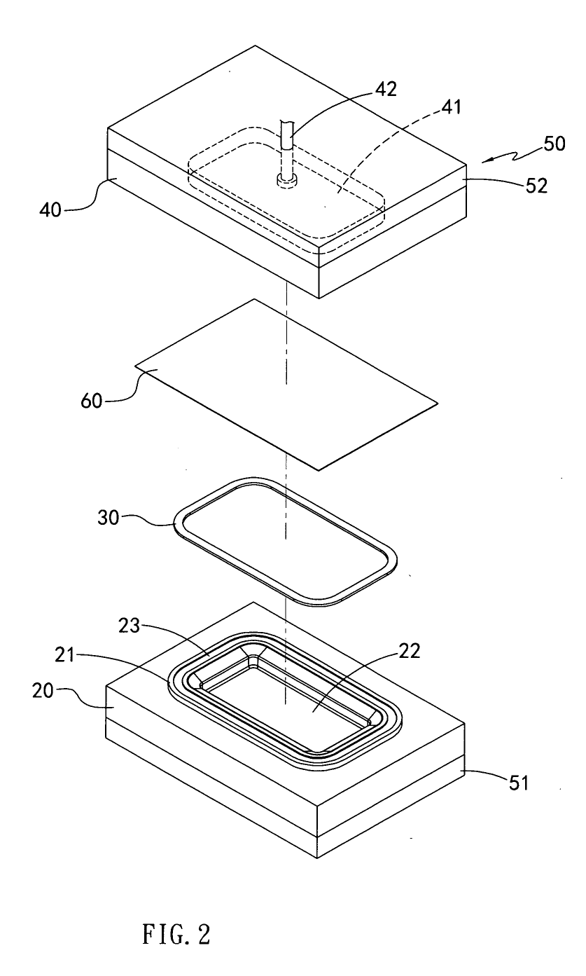

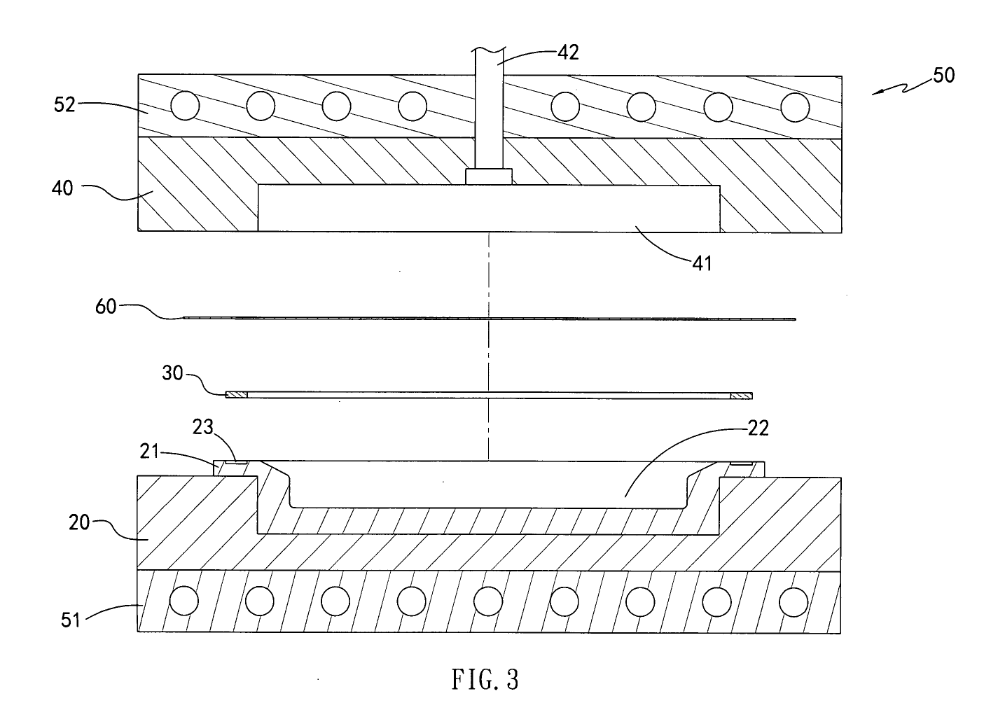

With reference to FIGS. 2 and 3, a mold structure according to a preferred embodiment of the present invention comprises: a first mold 20, an isolation washer 30, a second mold 40, and a heating device 50.

The first mold 20 includes a ring-shaped closing rib 21 arranged on a top surface thereof, a cavity 22 defined in the closing rib 21, and a fixing slot 23 formed around a peripheral side of a top surface of the closing rib 21.

The isolation washer 30 is formed in a ring shape and includes a melting point higher than a molding plate 60. For example, when the molding plate 60 is made of aluminum, the isolation washer 30 is made of stainless steel or copper; when the molding plate 60 is made of rubber or plastic, the isolation washer 30 is made of aluminum. When the isolation washer 30 retains with the fixing slot 23 of the closing rib 21, and a top surface of the isolation washer 30 is higher than that of the closing rib 21, the molding plate 60 is held by the isolation washer 30.

The second mold 40 moves relative to the first mold 20 to press a top surface of the molding plate 60. The second mold 40 includes a close chamber 41 defined on a bottom surface thereof and corresponding to the cavity 22 and includes a gas supply pipe 42 communicating with the close chamber 41 and connecting with a high-pressure gas device (not shown), such that the high-pressure gas device inputs high-pressure gas via the gas supply pipe 42.

The heating device 50 includes a first heater 51 disposed on a bottom surface of the first mold 20 and a second heater 52 mounted on a top surface of the second mold 40, such that the first heater 51 heats the first mold 20, and the second heater 52 heats the second mold 40, the molding plate 60 retained between the first mold 20 and the second mold 40 is molded at a heating temperature of the first heater 51 and the second heater 52.

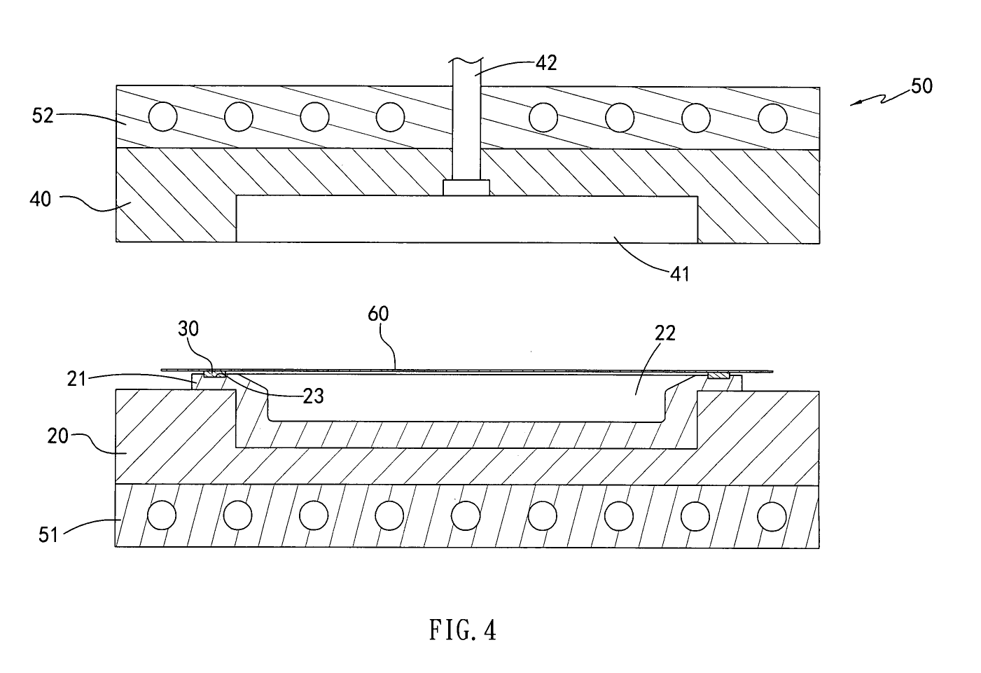

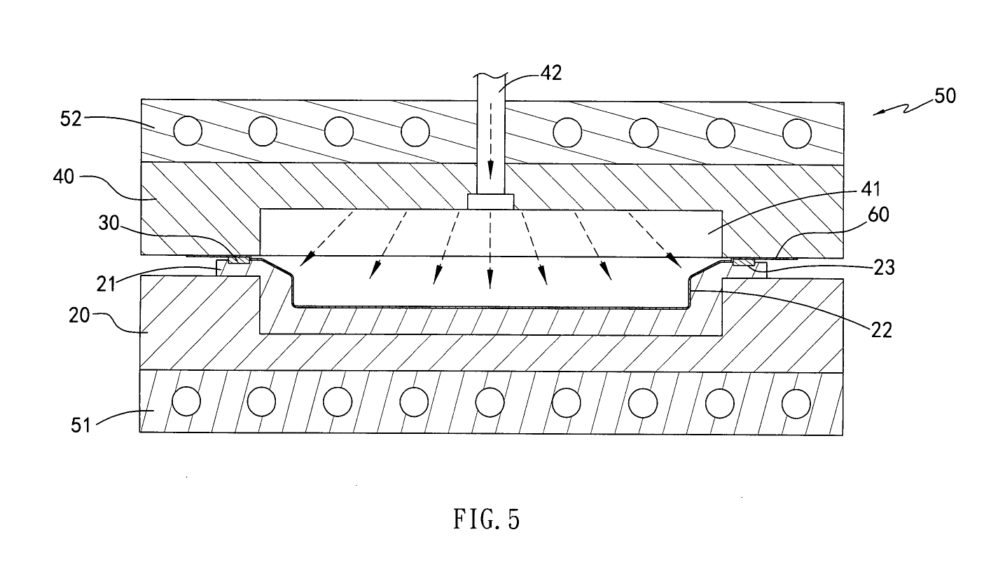

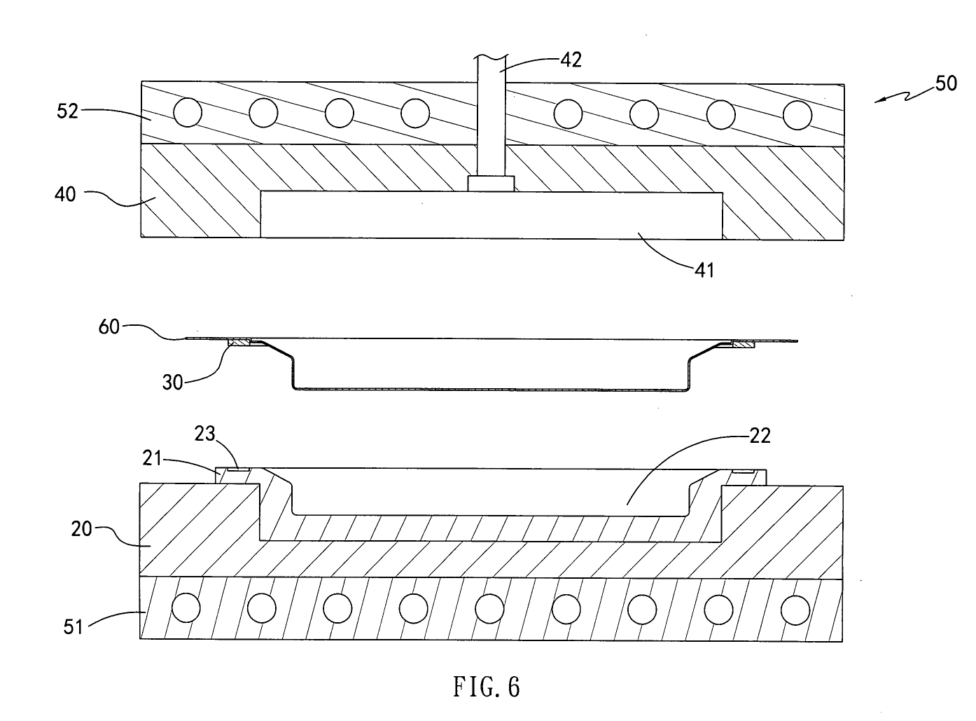

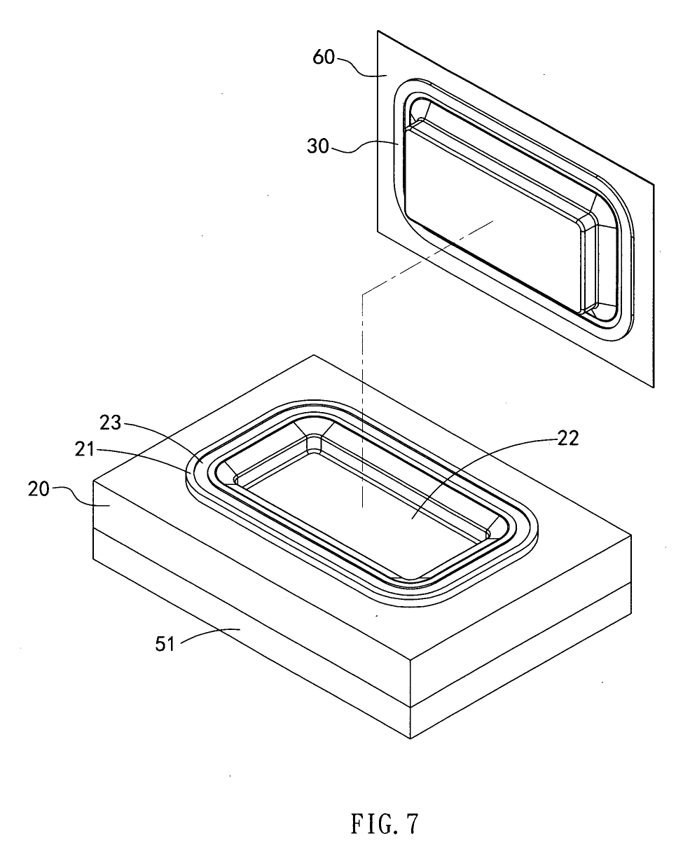

Referring to FIGS. 4 to 7, in operation, the isolation washer 30 is retained with the fixing slot 23, the molding plate 60 is placed on the isolation washer 30 to cover the cavity 22, and the second mold 40 is moved downwardly to press the molding plate 60. Thereafter, the first heater 51 heats the first mold 20, and the second heater 52 heats the second mold 40 to deform the molding plate 60 at the heating temperature, then the gas supply pipe 42 inputs the high-temperature gas into the close chamber 41, such that a pressure of the high-pressure gas pressures the molding plate 60 into the cavity 22, thus molding the molding plate 60 in a shape of the cavity 22. Thereafter, the second mold 40 is moved upwardly to remove the molding plate 60 and the isolation washer 30 from the first mold 20, and then an area of the molding plate 60 outside the isolation washer 30 is cut, thus obtaining a molding product.

Preferably, an anti-sticking layer (not shown) is plated on the cavity 22 of the first mold 20, such that the molding plate 60 forms patterns thereon by ways of the anti-sticking layer.

Thereby, the mold structure of the present invention has advantages as follows:

1. After the molding plate 60 is pressed by the first mold 20 and the second mold 40 and is heated by the heating device 50, the high-pressure gas device inputs the high-pressure gas into the close chamber 41 via the gas supply pipe 42 to blowing mold the close chamber 41, and the molding plate 60 does not stick on the first mold 20 by using the isolation washer 30 but sticks on the isolation washer 30. Since the melting point of the isolation washer 30 is higher than the molding plate 60, the isolating washer 30 does not stick on the cavity 20, such that after molding the molding plate 60, the molding plate 60 and the isolation washer 30 are removed from the first mold 20 easily.

2. After molding the molding plate 60, it sticks with the isolation washer 30 to enhance structural strength.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A mold structure being employed to blowing mold a molding plate comprising:
a first mold including a ring-shaped closing rib arranged on a top surface thereof and a cavity defined in the ring-shaped closing rib;
an isolation washer formed in a ring shape and including a melting point higher than a molding plate, wherein when the isolation washer retains with a fixing slot of the ring-shaped closing rib, and a top surface of the isolation washer is higher than that of the ring-shaped closing rib, the molding plate is held by the isolation washer;
a second mold moving relative to the first mold to press a top surface of the molding plate, the second mold including a close chamber defined on a bottom surface thereof and corresponding to the cavity, and the second mold also including a gas supply pipe communicating with the close chamber and connecting with a high-pressure gas device;
wherein the first mold also includes the fixing slot formed around a peripheral side of a top surface of the ring-shaped closing rib and retaining with the isolation washer;
wherein the isolation washer is made of stainless steel or copper.

2. The mold structure as claimed in claim 1 further comprising a heating device for heating the first mold and the second mold at a heating temperature.

3. The mold structure as claimed in claim 2, wherein the heating device includes a first heater disposed on a bottom surface of the first mold and a second heater mounted on a top surface of the second mold.

4. The mold structure as claimed in claim 1, wherein an anti-sticking layer is plated on the cavity of the first mold.

5. The mold structure as claimed in claim 2, wherein an anti-sticking layer is plated on the cavity of the first mold.

6. (canceled)

7. (canceled)

8. (canceled)

9. (canceled)

10. (canceled)

11. (canceled)

12. (canceled)

13. (canceled)
